(19) United States
(12) Patent Application Publication
(10) Pub. No.: US 2004/0186625 A1
(43) Pub. Date: Sep. 23, 2004

(54) System and method for retaining sensory data objectivity when sensory data is internalized by a system

(76) Inventors: Andrew J. Loscalzo, Bettendorf, IA (US); Joshua L. Benhart, Moline, IL (US); David E. Cutright, Moline, IL (US)

Correspondence Address: Hoffman, Wasson & Gitler, P.C., Suite 522, 2461 South Clark Street, Crystal Center 2, Arlington, VA, 22202, US

(21) Appl. No.: 10/804,026

(22) Filed: Mar. 19, 2004

Related U.S. Application Data
(60) Provisional application No. 60/456,224, filed on Mar. 21, 2003.

(51) Int. Cl. G06F 19/00

(52) U.S. Cl. 700/245

(57) ABSTRACT

A fully integrated system and method that provides for a system that generates fundamental differences between a host system and sensory data. The systems processing covers a series of contrasting sensory data ranges that are comprised of sensory streams, sight, sound, temperature, pressure, etc. The ranges establish a point of reference within a host system for contrast with external sensory data. The static range of the system is contrasted with the active range producing an impact variation (a measurable difference) between the ranges. The processing effected by the system utilizes the monitored impact variations resulting from the contrasting sensory ranges, in conjunction with multiple sensory stream integration to resolve the problem of retaining sensory data objectivity when sensory data is internalized by a system.

### FIELD OF THE INVENTION

The present invention relates generally to a computer based system and method for teaching existing artificial intelligence devices, such as embodied in personal computers, an unconditioned and a conditioned response.

### BACKGROUND OF THE INVENTION

Broadly speaking, existing systems operate on an input/output sequence which results in a programmed stimulus that elicits a programmed response. The problem encountered with this standard mode of operation is that current systems, by design, cannot retain sensory data objectivity when sensory data is internalized. Retaining sensory data objectivity is the process by which a system retains a difference between itself and sensory data. In order to retain a difference between a system and sensory data, a system must first generate a measurable difference. Existing systems lack a comparative process upon which differences are generated. The developmental focus of existing systems is on peripheral devices such as visual attention, reflex actions, head and neck orientation, balance, walking and stair climbing. Some systems that lack access to sensory data, such as a personal computer, process information only. There are no known prior attempts that resolve the problem of retaining sensory data objectivity when sensory data is internalized by a system.

U.S. Pat. No. 6,490,570, issued to Numaoka describes a system, such as used in artificial intelligence, to develop conditional reflexes. This system includes a conditioning unit adapted to receive signals indicative of the existence of unsatisfied operational requirements in application modules of the system. Signals indicative of the manifestation perceptible to external users of the existence of an unfilled operational requirements, as well as signals indicating the detection of satisfaction events are applied to the system. The system would then generate a signal indicating the probability of satisfaction of an unsatisfied operational requirement. However, this system does not anticipate the present invention of comparing received sensory data, and internalized sensory data, to produce an unconditioned and a conditioned response to one or more external stimuli.

### SUMMARY OF THE INVENTION

The shortcomings and limitations of the prior art are obviated, in accordance with the present invention, by providing a system and method for generating and retaining measurable differences between sensory data and internalized data.

In accordance with one aspect of the invention, a system and method for creating a system for the presentation and contrasting of random external sensory data within the system's active and static sensory ranges is provided. An active range reflecting external world sensory data is used as input variables to the system. Those active range variables are compared to a static range consisting of stationary sensory parameters as a constant. A comparative process results in an impact variation which is the measurable difference between the ranges. The degree of variation is determined by the intensity of the external stimulus, (sensory data reflected in the active range), when compared to the corresponding sensory stream in the static range. The degree of variation determines the response, which is drawn from an attraction (comfort) or avoidance (discomfort) platform. This is the primary or unconditioned response. The system then integrates the stimulus with the impact variation and the unconditioned response. This integrated data is stored in a memory for later use. A secondary, or conditioned response, is elicited when a match is found between the current stimulus and a previously processed stimulus stored in the memory.

Broadly speaking, the system and method provides for a system that through the use of the active and static sensory data ranges establishes a point of reference within a host system as a constant for comparison with external sensory data. This process generates a measurable difference between the system and the external world. Thus, the system retains sensory data objectivity when sensory data is internalized by the system. The present invention, by design, is adaptable to Artificial Intelligence systems, personal computers, robots, etc. These and other aspects of the invention are described in detail with reference to the accompanying figures.

### BRIEF DESCRIPTION OF THE DRAWINGS

FIG. 1 is a block diagram of components comprising a computer based automated system for processing, storing, and retrieving contrasting sensory data;

FIG. 2 is a flow diagram describing the specific processes of how the system receives sensory data, establishes a point of reference for contrast, elicits a primary (unconditioned) response, integrates, stores and retrieves the data for the secondary (conditioned) response; and

FIG. 3 is an example of the functions of the sensory range comparator, which is comprised of two ranges, active and static, and of the comparative percentile algorithm method used to rank and compare sensory data.

### DETAILED DESCRIPTION OF THE PREFERRED EMBODIMENT

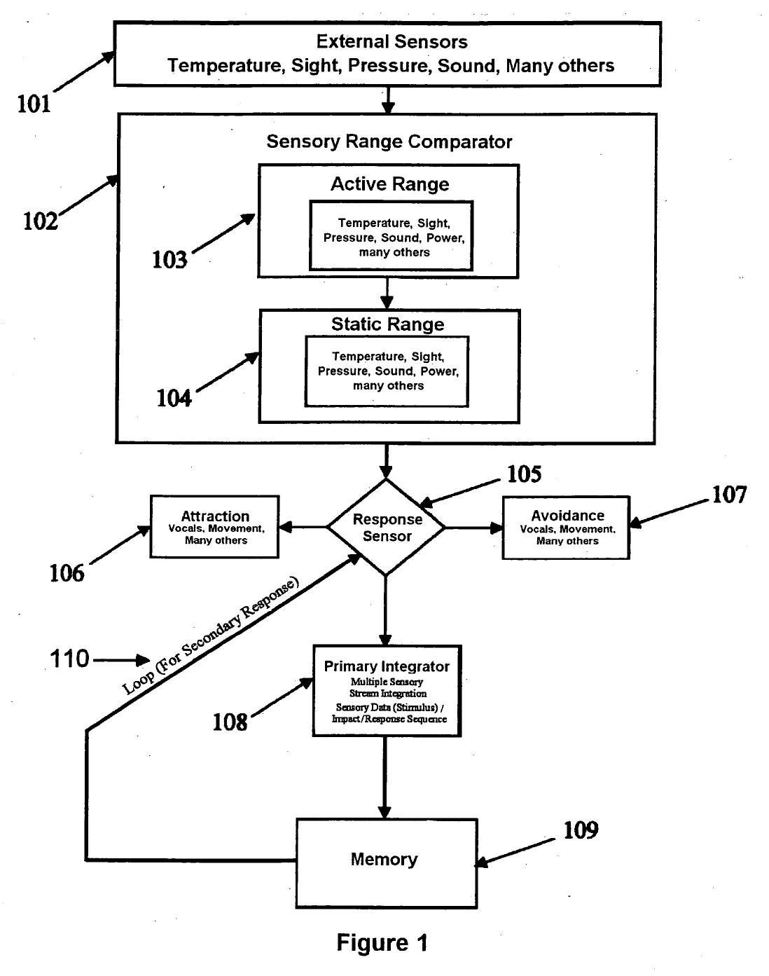

With reference to FIG. 1, there is shown a high-level block diagram of components comprising a computer based automated system. In particular, the system includes external sensors 101; a sensory range comparator 102; an active range 103; a static range 104; a response sensor 105; an attraction response 105; an avoidance response 107; a primary integrator 108; memory 109; and loop for a secondary response 110.

The system's sensors are depicted as external sensors 101, which applies the external sensory data to the system's sensory range comparator 102. The external sensory data is received by the sensory range comparator's active range 103, where sensory streams are ranked by order of intensity by use of a comparative percentile algorithm. The active range represents external, real world stimuli as variables. The process determines which data stream (sight, sound, temperature, pressure, power level, etc.) will be acted upon first. The data is then presented to the sensory range comparator's static range 104 for comparison. The static range 104 is the internal sensory parameter range, which includes tolerances, (a constant), of the system. The static range 104 is provided in a memory device. The difference between the active (external world) range and the static (internal system) range establishes an impact variation within the system. The impact variation is the difference of the static range from the active range. The degree of variation between the ranges (active vs. static) is then applied to the response sensor 105.

The response sensor determines either the attraction response 106, or the avoidance response 107 determined by the intensity of the impact variation and the residing system. The primary response, which is an unconditioned response, is elicited when a degree of variation is detected that exceeds an established sensory parameter tolerance in the static range. The primary integrator 108 associates the external stimulus with the impact variation and the response along with any additional sensory data processed with the adopted stimulus. The integrated data is then applied to memory 109. The system searches for a stimulus match (previously processed stimulus) in the memory 109. If a match for the stimulus is found, it will update the previously stored stimulus in memory with the immediate impact variation and response. In turn, the newly updated data is looped back 110 to the response sensor 105 to determine a secondary (conditioned) response. The system will only initiate a secondary (conditioned) response when a previously processed (stored) stimulus is found. If the system does not find a match for the current stimulus in memory 109, it will store the stimulus with the integrated data.

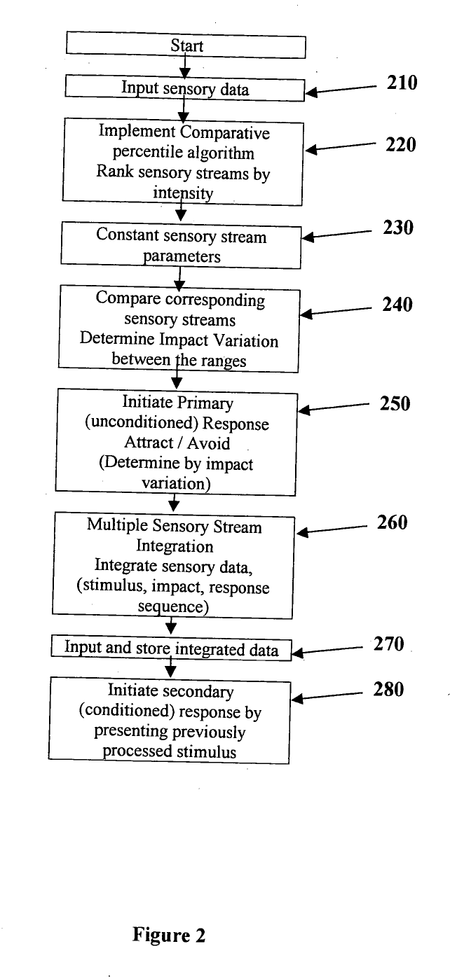

FIG. 2 illustrates a flow diagram demonstrating the process of the present invention. Starting with the external sensors 210, the system receives the external sensory streams. The data is then presented to the active range 220 where the system will rank sensory streams by order of intensity to determine priority. The data from the active range is then presented to the static range 230. A comparative process 240 determines the impact variation. The system will then initiate a primary (unconditioned) response (attraction or avoidance) 250. The impact variation and the response are then integrated with the stimulus 260. The integrated data is then transmitted to memory 270 where it is stored. When a previously processed stimulus is introduced to the system and identified as stored, a secondary (conditioned) response 280 is elicited. The process establishes an integrated stimulus/impact variation/response/storage/retrieval sequence.

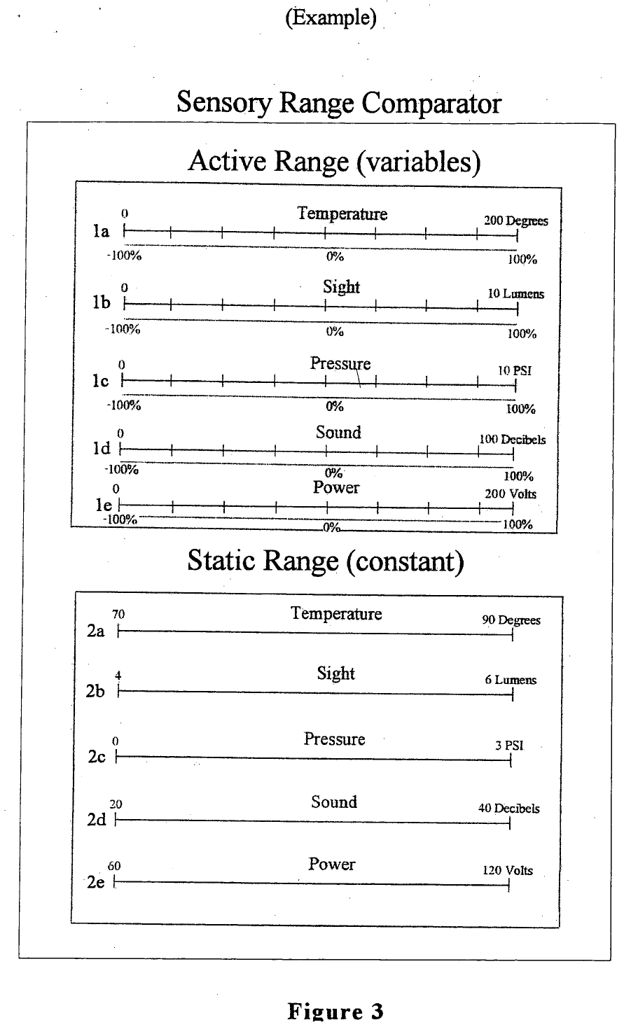

FIG. 3 depicts the system's sensory range comparator, which consists of an active range and a static range. The active range reflects actual external world sensory data as variables. Depicted are sensory streams, which are labeled as follows: temperature 1a, sight 1b, pressure 1c, sound 1d, and power 1e. In addition, each sensory stream is assigned a unit of measure, degrees, lumens, PSI, decibels, and volts. Further, a percentile algorithm method is applied to determine the intensity of each individual sensory stream. The comparative percentile algorithm method utilizes a percentage range from a positive one hundred, to zero, to a negative one hundred percent (using an absolute value for comparison).

After determining the value of each sensory stream, 1a-1e, the established percentage value of each active range stream is compared, to determine the sensory stream of the greatest intensity (the most extreme value from zero). This adopted sensory stream is then presented to it's corresponding constant sensory stream (static range), 2a-2e, for comparison. As the system sues auxiliary power (a finite supply), the actual power level is reflected in the active range, 1e, (as a variable) for comparison with the corresponding sensory parameter in the static range 2e (a constant). As the power level changes with use, (a drop or a surge), the system adopts the appropriate response.

Although illustrative embodiments of the present invention have been described above in connection with the drawings, it is foreseen that the invention is not to be limited to those precise embodiments and that various modifications can be made by persons skilled in the art without departing from the scope and spirit of the invention.

What is claimed is:

1. A method of eliciting a response to external stimuli by a robotic device having at least one movable device, comprising the steps of:
determining a static range of potential first stimuli;
inputting said static range into a first memory device;
sensing the actual value of said first stimuli;
calculating the intensity value of said actual value of said first stimuli;
comparing said intensity value of said active value for said first stimuli with said static range of said first stimuli to establish an impact variation; and
moving the movable device toward or away from the source of said first stimuli, based upon said comparing step.

2. The method in accordance with claim 1, wherein the movable device moves toward or away from the source of said first stimuli, based upon the intensity of said impact variation.

3. The method in accordance with claim 2, including the step of updating a second memory device based upon said impact variation with respect to said first stimuli.

4. The method in accordance with claim 3, further including the step of updating said first memory with said impact variations of said first stimuli, only when information relating to said first stimuli is found in said memory.

5. The method of eliciting a response to external stimuli by a robotic device having at least one movable device in accordance with claim 1, including the further steps of:
determining a static range of a potential for each of additional stimuli;
inputting said static range for each of said additional stimuli into a first memory device;
sensing the actual value of each of said additional stimuli;
calculating the intensity value of each of said actual values of each of said additional stimuli;
comparing said intensity value of said active value for each of said additional stimuli and said first stimuli with said static range of each of said additional stimuli to establish an impact variation for each of said additional stimuli; and
moving the movable device toward or away from the source of at least one of said first stimuli and said additional stimuli based upon said comparing step.

6. A system for eliciting a response to external stimuli by a robotic device having at least one movable device, comprising:
a plurality of sensors for sensing the actual value of a plurality of stimuli;
a calculating device for determining the intensity value of said active value of each of said stimuli;
a first memory device provided with a static range of each of said plurality of stimuli;
a comparison device for comparing said intensity value of each of said actual value with each other and for comparing said intensity values with said static range of values; and
an actuating device for actuating the movement of the at least one moveable device based upon an output generated by said comparison device.

7. The system in accordance with claim 6, further including a second memory device for including information stored therein based upon said intensity values of each of said plurality of stimuli.
